(19) United States
(12) Patent Application Publication
(10) Pub. No.: US 2003/0051000 A1
(43) Pub. Date: Mar. 13, 2003

(54) Image forming devices and image forming device operational methods

(76) Inventors: Bradley J. Anderson, Boise, ID (US); Bruce L. Johnson, Eagle, ID (US); Leonard T. Schroath, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/951,158

(22) Filed: Sep. 12, 2001

(51) Int. Cl. G06F 15/16

(52) U.S. Cl. 709/218; 709/228

(57) ABSTRACT

Image forming devices and image forming device operations methods are described. According to one aspect, an image forming device includes an image engine configured to form images upon media; memory configured to store user documentation information pertaining to the image forming device; and processing circuitry coupled with the image engine and the memory and configured to control the image engine to form a user documentation image upon media using the user documentation information.

### FIELD OF THE INVENTION

The present invention relates to image forming devices and image forming device operational methods.

### BACKGROUND OF THE INVENTION

Computer systems and peripheral devices thereof have enjoyed increased popularity and numerous developments in recent years. The increased uses of such devices and demands for devices having increased capabilities have resulted in numerous advancements. In particular, peripheral devices configured to form images, such as laser and ink printers, have enjoyed many advancements in imaging capabilities as well as imaging quality.

The increased sophistication of modern peripheral devices capable of performing enhanced capabilities has resulted in devices having enhanced hardware and software to accomplish the enhanced peripheral capabilities. Such improvements in peripheral hardware and software provide increased flexibility not only with respect to imaging operations but also with respect to auxiliary operations associated with the peripheral itself. For example, some devices are capable of communicating with external networks, such as the Internet.

Despite the improvements with printers and other peripheral devices, operational information regarding the printers is typically provided as hard-copy reference manuals and/or as a CD within the delivered box housing the printer. Often, hard copy manuals are hundreds of pages in length and are relatively expensive to print and ship with the printer product. Despite the expense of providing such hard copy manuals, the user may actually never reference the material. In addition, in a networked application, numerous printers may be implemented resulting in an equal number of user manuals when typically only one will be frequently referenced.

If operational information is provided upon a CD, an associated personal computer is typically utilized to access the information. A host device may not be conveniently accessible such as during installation of a printer in a typical remote network location. Further, if the user desires to print the information, an installed printer may be needed and may not be available if no conventional printers have as of yet been installed and ready to print information from the personal computer.

Further, during development and engineering of printers and other peripherals, changes may be made relatively late in the design process. Such may result in changes to the user documentation. Accordingly, problems arise with providing up-to-date information if printing of hard copy manuals or CDs has already occurred and subsequent changes to the device are implemented. Updates to the information may be available but a personal computer is typically required to access the information (e.g., from a web site of the manufacturer).

There exists a need to provide improved devices and methodologies which overcome these and other shortcomings in the art.

### SUMMARY OF THE INVENTION

Image forming devices and image forming device operational methods are provided according to aspects of the present invention. According to one aspect, an image forming device includes an image engine configured to form images upon media; memory configured to store user documentation information pertaining to the image forming device; and processing circuitry coupled with the image engine and the memory and configured to control the image engine to form a user documentation image upon media using the user documentation information.

Another aspect provides an image forming device comprising: an image engine configured to form images upon media; a user interface configured to receive input commands; a communications interface adapted to communicate externally of the image forming device; memory configured to store original user documentation information pertaining to the image forming device; and processing circuitry coupled with the image engine and the memory and configured to automatically control communication of a user documentation request without user input via the communications interface to stimulate the communication of updated user documentation information, to control the storage of the updated user documentation received via the communications interface responsive to the communication of the user documentation request, to automatically control the image engine to form an instruction image without user input, to control the image engine to form a plurality of user documentation images responsive to the reception of a predetermined input command via the user input responsive to the formation of the instruction image, and wherein the user documentation images correspond to the user documentation information comprising at least one of the original user documentation information and the updated user documentation information, and wherein the processing circuitry is further configured to detect a predetermined moment in time and to delete the original user documentation information and the updated user documentation information from the memory responsive to the detection of the predetermined moment in time.

According to another aspect, an image forming device operational method comprises storing user documentation information pertaining to an image forming device within memory of the image forming device; retrieving the user documentation information from the memory; and forming a user documentation image including the user documentation information.

Other aspects are provided, some of which are described below. Other features and advantages of the invention will become apparent to those of ordinary skill in the art upon review of the following detailed description, claims, and drawings.

### DESCRIPTION OF THE DRAWINGS

FIG. 1 is an illustrative representation of an exemplary image forming system coupled with a network and a remote device in an exemplary implementation.

FIG. 2 is a functional block diagram of components of an exemplary image forming device.

FIG. 3 is a functional block diagram of components of an exemplary memory of the image forming device.

FIG. 4 is a flow chart of an exemplary methodology executable within the image forming device.

### DETAILED DESCRIPTION OF PREFERRED EMBODIMENTS

As described herein, aspects of the present invention provide devices and methods for accessing or otherwise providing user documentation with respect to an image forming device. Exemplary user documentation includes information with respect to installation, operation, consumables, troubleshooting, and any other functions or information with respect to an image forming device. User documentation includes original user documentation and\or updated user documentation. Original user documentation refers to user documentation at an initial moment in time, such as the moment in time when the image forming device is manufactured, shipped or other moment in time. Updated user documentation refers to new user documentation occurring after the initial moment in time to provide accurate, up-to-date reference information to end users. Provision of updated user documentation allows an engineering team of the manufacturer of device 12 or other party to provide updated information according to aspects of the invention.

As used herein, user documentation and user documentation images are used interchangeably to refer to hard copy images containing user documentation information generated by image forming device 12 as described below. User documentation information comprises information embodied within memory of an image forming device, remote device (described below) or other appropriate location and which is utilized to form user documentation or user documentation images.

The user documentation and user documentation information may individually include a plurality of portions comprising chapters in one example. The portions are divided by subject matter and can refer to different instructions or operations including for example, installation, operations, consumables, troubleshooting, or any other convenient division of subject areas.

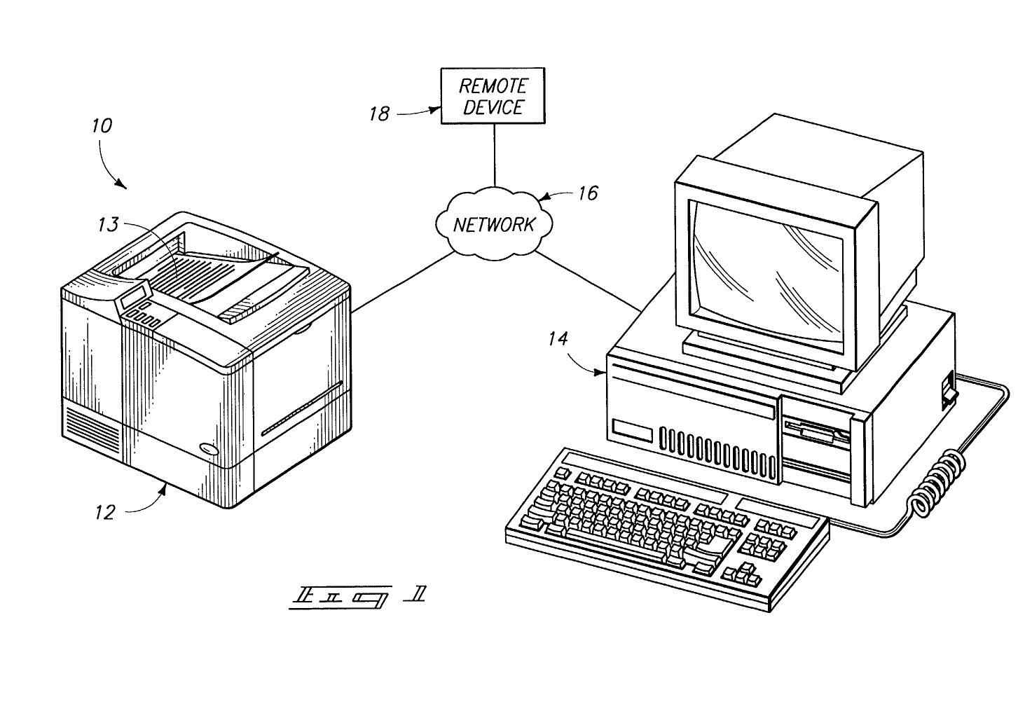

FIG. 1 depicts an exemplary image forming system 10 including one or more image forming device 12 and one or more host device 14 (only one device 12 and one device 14 are depicted in FIG. 1). Image forming system 10 is coupled with a network 16 and a remote device 18 in the depicted arrangement. Dedicated, stand alone, implementations and other implementations of image forming device 12 are also provided.

Image forming device 12 is configured to utilize one or more consumable(s) to form hard images. Exemplary consumables utilized within a given image forming device include imaging media (e.g., paper, labels, transparencies, roll media, etc.), marking agents (e.g., toner, ink), components having fixed life spans (e.g., developer assembly) and other expendable items utilized to complete desired jobs.

Exemplary configurations of image forming device 12 include printers, facsimile devices, copiers, multiple-function devices or other devices capable of forming hard images upon media 13. Exemplary hard or hard copy images include images provided upon output media comprising printed media in one example.

An exemplary host device 14 is implemented as a personal computer having an Intel™ processor or AMD™ processor (not shown). Host device 14 provides data to be imaged to image forming device 12. In addition, host device 14 may be associated with a user of image forming device 12 and/or other personnel, such as a system administrator, who monitors or otherwise accesses image forming device 12. Other host device 14 configurations are possible.

As described further below, remote device 18 is configured to communicate with one or more image forming device 12 and host device 14. Remote device 18 is implemented as a server configured to communicate with network 16 in the described exemplary embodiment. Remote device 18 is maintained by a proper party, such as a manufacturer, supplier, contractor or other party in some arrangements.

As described herein, and according to exemplary aspects of the present invention, image forming device 12 accesses remote device 18 via network 16 to retrieve user documentation information, including original or updated user documentation information, regarding operations of image forming device 12.

More specifically, image forming device 12, host device 14 and remote device 18 are configured to communicate with one another in the described embodiment using an appropriate communication medium comprising network 16, for example. An exemplary network 16 utilized to implement such communications includes a public network (e.g., the Internet) and/or a private network (e.g., local area network). For example, image forming device 12, host device 14 and remote device 18 are configured to implement Web communications via network 16 in one embodiment.

In some arrangements, a plurality of image forming devices 12 and host devices 14 communicate with remote device 18. Accordingly, operations of remote device 18 described herein may be performed with respect to a plurality of image forming devices 12 and/or host devices 14. Image forming devices 12 and/or host devices 14 communicate with remote device 18 to implement operations described herein according to exemplary aspects.

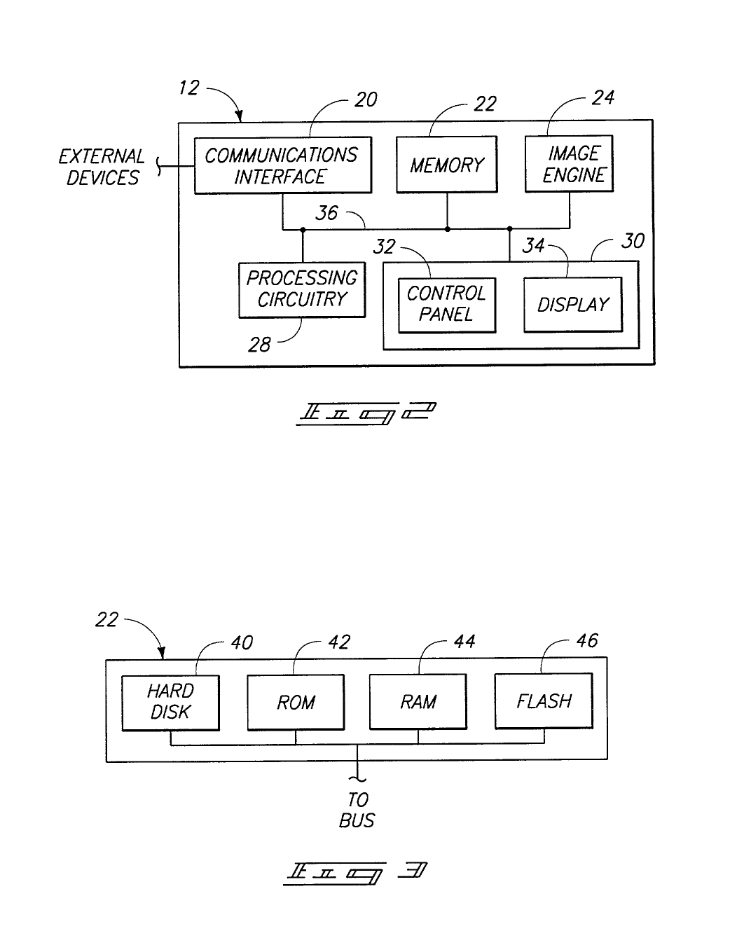

Referring to FIG. 2, components of an exemplary image forming device 12 are illustrated. Some of the depicted components are optional and other arrangements of image forming device 12 configured to form hard images are possible. The exemplary embodiments disclosed herein are discussed with reference to image forming device 12 implemented within a printer application although the present invention applies to any image forming device configuration capable of forming hard images.

As shown, the exemplary image forming device 12 includes a communications interface 20, a memory 22, an image engine 24, processing circuitry 28, a user interface 30 and a bus 36. Bus 36 is configured to implement communications intermediate the respective coupled components of image forming device 12.

Communications interface 20 is configured to couple with a communication medium, including for example network 16, to implement communications with external devices including host device 14, remote device 18 and other devices. An exemplary communication interface 20 comprises a network interface card (NIC), modem or other configuration configured to implement external communications with respect to image forming device 12.

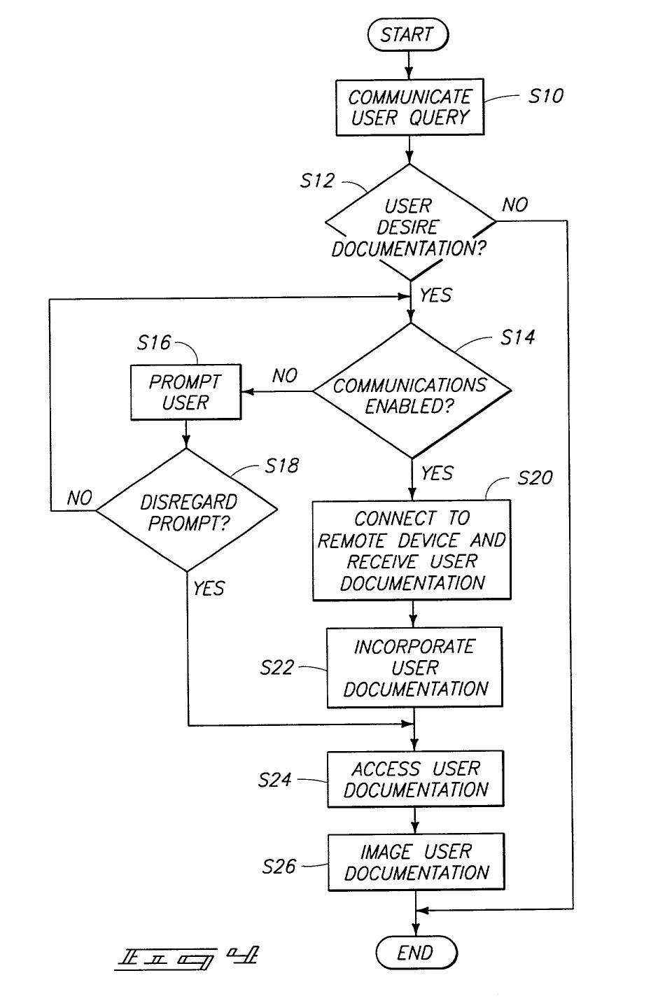

Memory 22 comprises computer usable media configured to store executable instructions configured to cause processing circuitry 28 to perform imaging operations and other operations including providing user documentation in accordance with aspects of the present invention. Memory 22 is configured to store digital information including user documentation information and instructions usable to control operations within image forming device 12. For example, memory 22 is configured to store image data to be imaged using image engine 24, executable instructions usable by processing circuitry 28 to implement imaging operations and to control operations of image forming device 12 including operations described herein with respect to conveying user documentation information to a user, as well as other digital data to be stored within image forming device 12. Further details regarding memory 22 are discussed below with respect to FIG. 3.

Image engine 24 implements the formation of hard images upon media 13 using one or more consumable(s). According to the exemplary described printer embodiment, image engine 24 is implemented as a print engine. An exemplary print engine includes a developing assembly and a fusing assembly (not shown) to respectively develop hard images using marking agents and to affix the marking agents to media 13. Other constructions or embodiments of image engine 24 are possible.

Processing circuitry 28 is configured to execute executable instructions to control operations of image forming device 12 and to implement operations with respect to conveying user documentation information to a user as described herein according to aspects of the invention. Processing circuitry 28 is configured to execute executable instructions stored within memory 22 and comprising, for example, software and/or firmware instructions. Exemplary processing circuitry 28 is implemented as a microprocessor in but one embodiment.

According to additional aspects of the present invention, processing circuitry 28 is configured to function in conjunction with other appropriate components of device 12 as an embedded web server to communicate with external devices such as host device 14, remote device 18 and/or other external devices. Exemplary embedded web server operations of an image forming device are described in U.S. Pat. No. 5,956,487, incorporated herein by reference. Other configurations for implementing external communications by image forming device 12 are possible.

User interface 30 comprises a control panel 32 and a display 34 in one exemplary embodiment. A user inputs commands via control panel 32 comprising a keypad for example. As described further below, a user inputs commands via control panel 32 to access user documentation according to aspects of the present invention. Processing circuitry 34 controls the display to depict status and other messages pertinent to image forming device 12, and including information relative to accessing user documentation.

Referring to FIG. 3, an exemplary configuration of memory 22 is shown. Memory 22 comprises internal memory of image forming device 12 and includes a hard disk 40, read only memory 42, random access memory 44 and flash memory 44 in the depicted exemplary embodiment. Although not illustrated in FIG. 3, associated circuitry and components (e.g., hard drive controller) are provided to access components of memory 22.

Memory 22 is configured to store user documentation information of image forming device 12 according to aspects of the present invention. For example, when the image forming device 12 is manufactured, current user documentation information (also referred to as original user documentation information) may be stored within memory 22 before shipment of the device 12. The user documentation information may be stored within hard disk 40 or flash memory 46 in exemplary configurations. User documentation information is stored within other storage components of device 12 in other configurations.

Updates may occur to the original user documentation information as mentioned above. Such updates may result from customer inquiries, improvements to the associated device 12, or for other reasons. Updates to the user documentation information are available from remote device 18 comprising a server in the described exemplary configuration or from other external sources such as a floppy disk for configurations of device 12 having an associated floppy disk drive.

Instructions are provided within memory 22 (e.g., within ROM 42 in one exemplary configuration) to enable processing circuitry 28 of image forming device 12 to access original and\or updated documentation information. According to a first exemplary aspect, and upon application of power to image forming device 12 for the first or other specified time, processing circuitry 28 configured to implement embedded web server functionality accesses remote device 18 via network 16 to determine if updated user documentation information is available. In one exemplary configuration, remote device 18 comprises a server as mentioned above which hosts a web site, such as hp.com, accessible by a plurality of image forming devices 12 and configured to provide user documentation information to one or more image forming device 12 as described herein.

In particular, processing circuitry 28 is configured to formulate a user documentation request and to apply the request to communications interface 20 following successful powering of device 12. Processing circuitry 28 addresses the request for communication to remote device 18. In addition, processing circuitry 28 includes appropriate information with the request to stimulate communication of user documentation information within remote device 18 to device 12. For example, processing circuitry 28 may identify the communicating image forming device 12 by serial number and model number and provide an address location so remote device 18 can address any user documentation information for proper communication back to device 12. Following formulation of the request, processing circuitry 28 forwards the request to communications interface 20 which communicates the request to remote device 18 using network 16.

In the above described example, original user documentation information is provided within memory 22 and the request is communicated to access any updated user documentation information.

According to other aspects of the present invention, no user documentation information is originally provided within memory 22. Instead, processing circuitry 28 formulates and communicates the above-mentioned user documentation request to remote device 18 to stimulate communication of original and\or updated (if present) user documentation information from remote device 18 to image forming device 12.

According to exemplary aspects of the present invention, image forming device 12 is configured to automatically formulate and communicate the above-mentioned request to remote device 18 upon initial power-up without any user intervention. Alternatively, upon initial power-up of device 12, processing circuitry 28 controls display 34 to prompt the user to indicate whether they wish to receive user documentation information from remote device 18 and thereafter formulates the request following an indication from the user of a desire to receive such information via control panel 32.

Remote device 18 is configured to receive the user documentation request and to search for appropriate user documentation information for the image forming device 12 which communicated the request. For example, remote device 18 can utilize the model number, serial number or other appropriate identifier within the request to search for appropriate user documentation information. As discussed above, such user documentation information may include original and\or updated user documentation information. Following retrieval of the appropriate user documentation information, remote device 18 is configured to formulate a reply for communication to image forming device 12. Remote device 18 provides the retrieved user documentation information within the reply communicated to image forming device 12 in one example.

Referring again to image forming device 12 and once user documentation information is available, a user may utilize user documentation to assist with installation and\or other operations of device 12. Aspects of the present invention provide different modes of communicating options with respect to accessing user documentation information to the user.

According to one aspect, upon application of power to image forming device 12 for the first or other time, processing circuitry 28 is configured to automatically control image engine 24 to print or otherwise form an instruction image upon media 13 without user intervention. Such instruction image may include instructions specifying how to print or otherwise access one or more portion(s) of user documentation information either originally provided within memory 22 upon shipment of device 12 and\or from remote device 18. In addition, the instruction image may also include instructions how to initiate formulation and communication of the user documentation request if such is not performed automatically. According to other aspects, processing circuitry 28 prompts a user via the display 34 to determine whether the user wishes to print the instruction image.

A user may utilize control panel 32 to implement imaging of the instruction image if not performed automatically, to implement communication of the user documentation request if not performed automatically, or to implement printing or other image formation of one or more portion of the user documentation information if not performed automatically.

According to additional aspects, a “getting started” hard copy manual may be provided with the shipped image forming device 12 to assist a user with accessing user documentation information. Such a manual could be utilized by itself or in addition to the instruction image to assist the user. The manual is brief and refers to basic operations (e.g., installing media 13, installing marking agents or other consumables, etc.) in typical arrangements.

Image forming device 12 awaits the reception of user documentation information or other reply from remote device 18 following communication of a user documentation request as described above. The reply is received via communications interface 20. In one configuration, processing circuitry 28 is configured to store received user documentation information within memory 22. Such storage may be temporary or permanent if desired by the user (i.e., in one embodiment temporary storage is within volatile portions of memory 22 while permanent storage is within nonvolatile portions of memory 22).

In addition, the user documentation information received from remote device 18 may comprise original and\or updated user documentation information. In configurations wherein the image forming device 12 is originally shipped with original user documentation information, processing circuitry 28 is configured to supplement the original user documentation information and\or replace one or more portions of the original user documentation information with the user documentation information received from remote device 18. If no user documentation information is provided within device 12 before shipment, the received user documentation information comprises an entirety of the user documentation information pertaining to device 12.

Processing circuitry 28 is configured to communicate imaging options of the user documentation information to the user using display 34 in one exemplary configuration. For example, processing circuitry 28 controls display 34 to depict available user documentation which may be imaged or other appropriate indicator and prompts a user to determine if any portions of the user documentation information should be imaged for use by the user. The user may input commands via control panel 32. Following an indication of a desire of the user to receive user documentation information via an appropriate predetermined input command or by other methodology, processing circuitry 28 controls image engine to form user documentation images upon media 13 corresponding to and using one or more portion of the user documentation information desired by the user. Such user documentation images can include original and\or updated user documentation information.

The present invention also provides in other alternative embodiments, automatic imaging of user documentation information without user intervention. According to such aspects, processing circuitry 28 may or may not submit an automatic user documentation request to receive user documentation information from remote device 18 without user intervention. Processing circuitry 28 operates to automatically image user documentation information originally provided within memory 22 upon shipment of device 12 and/or user documentation information received from remote device 18 without user input according to these aspects.

According to additional aspects of the invention, processing circuitry 28 is configured to delete one or more portions of the user documentation information. For example, in one configuration, one or more portions of user documentation information (e.g., documentation files upon hard disk 40) may be associated with a time stamp. Such may be stamped according to a predetermined moment in time, predetermined amount of time after installation of device 12 or other appropriate time indicator. Processing circuitry 28 is configured to access and detect the predetermined moment in time, amount of time, or other time indicator. Upon such detection, processing circuitry 28 is configured to automatically delete the associated respective one or more portion of the user documentation information from memory 22 to free memory resources without user intervention. Alternatively, processing circuitry 28 queries the user via display 34 following the detection to determine if the user wishes for such user documentation information to be deleted or to modify the time at which the user documentation information will be deleted if modification is desired.

As described, some aspects of the present invention enable a user to print manuals without the presence of a host device or a network installation. A user can access user documentation using the control panel 32 for example without coupling of the image forming device 12 with a personal computer, network connection or other installation. Aspects of the present invention enable access to user documentation information without the use of an associated host device. Access to latest up-to-date user documentation information is also provided via network 16 or other source according to additional aspects. Further, information engineering or other development teams may lengthen their user documentation information release date closer to product release providing more accurate, up-to-date manuals (e.g., just-in-time documentation) according to aspects of the invention. In addition, the user documentation information may be printed before installation of the image forming device 12 according to aspects of the invention to assist a user with installation of the image forming device 12.

Referring to FIG. 4, an exemplary methodology executable by processing circuitry 28 is shown. Executable code operable to cause processing circuitry 28 to execute the indicated methodology may be stored within memory 22. Other methodologies may be utilized to implement aspects of the present invention. For example, some illustrated method steps may be omitted according to such other methods. In other alternative configurations, the depicted methodology of FIG. 4 is implemented within hardware.

Initially, processing circuitry 28 proceeds to step S10 to communicate a user query via display 34. The query at step S10 is formulated to inquire whether the user wishes to print or otherwise access user documentation.

At a step S12, processing circuitry 28 awaits the input of a response via control panel 32.

The indicated methodology ends if the response to step S12 is negative.

Alternatively, processing circuitry 28 proceeds to a step S14 responsive to the condition of step S12 being affirmative. At step S14, processing circuitry 28 determines whether external communications have been enabled via communications interface 20 permitting image forming device 12 to communicate with external devices.

If the condition of step S14 is affirmative, processing circuitry 28 proceeds to a step S20 to connect to remote device 18. As described above, processing circuitry 28 may formulate a user documentation request for submission to remote device 18. Such prompts the downloading of original and/or updated user documentation via network 16.

At a step S22, processing circuitry 28 operates to incorporate the received user documentation with any user documentation information already provided within memory 22. Such can include for example supplementing user documentation stored within memory 22, replacing user documentation information stored within memory 22 or alternatively comprise an entirety of the user documentation information to be communicated to the user.

If the condition of step S14 is negative, processing circuitry 28 controls display 34 to prompt a user to enable external communications via communications interface 20 if it is desired to receive user documentation information from sources external of image forming device 12.

At a step S18, processing circuitry 28 determines whether the user disregards the prompt and whether or not the user wishes to receive or download user documentation from remote device 18.

If the condition of step S18 is negative, processing circuitry 28 returns to step S14 and proceeds as previously described.

If the condition of step S18 is affirmative, processing circuitry 28 proceeds to a step S24 to access user documentation information comprising information originally stored within memory 22 and/or user documentation information received from remote device 18.

At a step S26, processing circuitry 28 controls image engine 24 to image the user documentation information providing the user documentation.

The protection sought is not to be limited to the disclosed embodiments, which are given by way of example only, but instead is to be limited only by the scope of the appended claims.

What is claimed is:

1. An image forming device comprising:
an image engine configured to form images upon media;
memory configured to store user documentation information pertaining to the image forming device; and
processing circuitry coupled with the image engine and the memory and configured to control the image engine to form a user documentation image upon media using the user documentation information.

2. The device of claim 1 further comprising a user interface configured to receive input commands, and wherein the processing circuitry is configured to control the image engine to form the user documentation images responsive to the reception of a predetermined input command.

3. The device of claim 1 wherein the processing circuitry is configured to control the image engine to form an instruction image.

4. The device of claim 1 further comprising a communications interface adapted to communicate externally of the image forming device, and wherein the processing circuitry is configured to communicate a user documentation request externally of the image forming device using the communications interface to stimulate communication of the user documentation information, and to control storage of the user documentation information using the memory.

5. The device of claim 4 wherein the processing circuitry is configured to automatically generate the user documentation request without user input.

6. The device of claim 1 wherein the memory is configured to store the user documentation information comprising original user documentation information, and further comprising a communications interface adapted to communicate externally of the image forming device, and wherein the processing circuitry is configured to communicate a user documentation request externally of the image forming device using the communications interface to stimulate the communication of updated user documentation information, and to control the image engine to form user documentation images corresponding to the user documentation information comprising at least one of the original user documentation information and the updated user documentation information.

7. The device of claim 6 wherein the processing circuitry controls the image engine to form the user documentation images corresponding to only the updated user documentation information.

8. The device of claim 6 wherein the processing circuitry controls the image engine to form the user documentation images corresponding to only the original user documentation information.

9. The device of claim 6 wherein the processing circuitry is configured to detect a predetermined moment in time and to delete at least a portion of the user documentation information from the memory responsive to the detection of the predetermined moment in time.

10. An image forming device comprising:
an image engine configured to form images upon media;
a user interface configured to receive input commands;
a communications interface adapted to communicate externally of the image forming device;
memory configured to store original user documentation information pertaining to the image forming device; and
processing circuitry coupled with the image engine and the memory and configured to automatically control communication of a user documentation request without user input via the communications interface to stimulate the communication of updated user documentation information, to control the storage of the updated user documentation received via the communications interface responsive to the communication of the user documentation request, to automatically control the image engine to form an instruction image without user input, to control the image engine to form a plurality of user documentation images responsive to the reception of a predetermined input command via the user input responsive to the formation of the instruction image, and wherein the user documentation images correspond to the user documentation information comprising at least one of the original user documentation information and the updated user documentation information, and wherein the processing circuitry is further configured to detect a predetermined moment in time and to delete at least a portion of the original user documentation information and the updated user documentation information from the memory responsive to the detection of the predetermined moment in time.

11. An image forming device operational method comprising:
storing user documentation information pertaining to an image forming device within memory of the image forming device;
retrieving the user documentation information from the memory; and
forming a user documentation image including the user documentation information.

12. The method of claim 11 further comprising receiving a predetermined input command, and wherein the forming comprises forming responsive to receiving the predetermined input command.

13. The method of claim 11 further comprising forming an instruction image upon media.

14. The method of claim 11 further comprising communicating a user documentation request externally of the image forming device to stimulate communication of the user documentation information.

15. The method of claim 14 further comprising automatically communicating the user documentation request without user input.

16. The method of claim 11 further comprising the storing comprises storing original user documentation information, and further comprising:
communicating a user documentation request externally of the image forming device to stimulate communication of updated user documentation information; and
receiving the updated user documentation information, wherein the forming comprises forming the user documentation image including at least one of the original user documentation information and the updated user documentation information.

17. The method of claim 16 wherein the forming comprising forming the user documentation image including the original user documentation information and the updated user documentation information.

18. The method of claim 16 wherein the forming comprising forming the user documentation image including only the original user documentation information.

19. The method of claim 16 wherein the forming comprising forming the user documentation image including only the updated user documentation information.

20. The method of claim 11 further comprising:
detecting a predetermined moment in time; and
deleting the user documentation information from the memory responsive to the detecting.
